(19) United States
(12) Patent Application Publication
(10) Pub. No.: US 2025/0053036 A1
(43) Pub. Date: Feb. 13, 2025

(54) LIQUID CRYSTAL DISPLAY DEVICE THAT HAS ELASTIC BACK STRUCTURE AND IS ERASABLE

(71) Applicant: Kent Displays, Inc., Kent, OH (US)

(72) Inventors: Clinton Braganza, Kent, OH (US); Paul J. von Mohr, Kent, OH (US)

(21) Appl. No.: 18/232,457

(22) Filed: Aug. 10, 2023

(51) Int. Cl. G02F 1/1333; G02F 1/135; G02F 1/137

(52) U.S. Cl. CPC G02F 1/133305; G02F 1/13338; G02F 1/1351; G02F 1/13718

(57) ABSTRACT

A liquid crystal display device includes a flexible front substrate, a liquid crystal layer comprising cholesteric liquid crystal material, and: i) a flexible back substrate and an elastic material layer; or ii) an elastic back substrate. The flexible front substrate is located more proximal to a person viewing the liquid crystal display device than is the liquid crystal layer. The i) flexible back substrate and the elastic material layer; or ii) the elastic back substrate, when present, are located in back of the liquid crystal layer. Pressure on the flexible front substrate changes a texture of the cholesteric liquid crystal material which displays an image. The pressure is from at least one of: i) impact of a projectile, a corresponding image including an impact mark; ii) a writing instrument, a corresponding image including writing or drawing; and iii) an imprinting instrument, a corresponding image including an imprinted image. Application of an electric field to the liquid crystal layer or flexing of the liquid crystal layer erases at least a portion of the image. Another aspect is a liquid crystal display device that includes a flexible front substrate, a liquid crystal layer comprising cholesteric liquid crystal material, and an elastic back structure that makes the liquid crystal display device elastic.

### TECHNICAL FIELD

This disclosure relates to the field of cholesteric liquid crystal display devices that are marked by applying pressure.

### BACKGROUND

In 2010, the Boogie Board® pressure sensitive writing tablet of Kent Displays Inc. appeared on the market (see U.S. Pat. Nos. 6,104,448 and 8,139,039 incorporated by reference). It has become a popular paper replacement for household, classroom and office work offering the convenience of writing and drawing with a simple stylus, even a fingernail, and quick erase for repeated use. Over the years, numerous versions of cholesteric writing tablets, large and small, have appeared in the marketplace. They are substantially all constructed the same way in which a pressure sensitive cholesteric liquid crystal writing panel is housed within a rigid plastic casing with a bezel in front that holds it in place. The purpose of the housing is to protect the panel from damage and to accommodate the electronics and button switch used to erase the written image and initialize the tablet for forming a new image. The housing further provides pressure support for the stylus.

The technology of the BOOGIE BOARD® writing tablet uses a unique feature of cholesteric liquid crystals, wherein the liquid crystal material is suitably sandwiched between two substrates. The front substrate is flexible for forming the front surface or writing surface for writing and drawing. To achieve clear writing the front substrate locally deforms upon applying pressure from a stylus or a fingernail against a rigid back structure. In the prior art BOOGIE BOARD® writing tablet the liquid crystal is initially in a generally transmissive texture known as the focal conic texture that allows the user to see the light absorbing background of the device provided by the back substrate or a coating or layer on the back substrate that is usually dark in color. Applying a localized pressure with a fingernail or a hard pointed stylus on the writing surface causes the focal conic texture to change to a reflective texture known as the planar texture. Normally, the stylus is moved to traverse across the viewing area of the device while applying pressure, when writing on the device, drawing pictures on the device, or the like, similar to writing with a pen on paper. The color of the planar texture is determined by the pitch length of the cholesteric liquid crystal. The image is erased to form a clean page by initializing the writing device to the generally transmissive or focal conic texture. To do so, one applies voltage (see, for example, U.S. Pat. No. 10,558,065 which is incorporated by reference) to transparent electrically conductive layers on the inner surface of the substrates in response to pushing a button on the writing tablet. Both the focal conic and planar textures are stable and require no voltage to be maintained. The only voltage that is used is an erasing voltage pulse applied to the electrically conductive layers that transitions all the liquid crystal layer, including the planar texture of marks, to the focal conic texture. Cholesteric liquid crystal writing and drawing tablets of the prior art are made resistant to abusive use, avoiding significant bending or flexing since the writing panel is protected from delamination or otherwise damage by the rigid casing and the rigid bezel.

Cholesteric liquid crystal writing tablets have been disclosed for use without the panel being housed in a casing, termed liquid crystal paper, as disclosed in U.S. Pat. No. 9,651,813. Without a casing, the liquid crystal paper devices need to be placed on a rigid or hard surface for writing or drawing as there is no casing to provide pressure support for the stylus. This prevents substantial local deformation of the back substrate when the device is written on. An issue arises, however, in that, without a casing, these liquid crystal paper devices are not very rugged for handling and, in particular, abusive handling can delaminate the liquid crystal paper if not sufficiently packaged in a rigid framework or casing. Being insufficiently resistant to abusive use without a casing the liquid crystal paper device was never commercialized.

### SUMMARY OF THE DISCLOSURE

In a general embodiment, a liquid crystal display device of the present disclosure that is erasable, comprises a flexible front substrate; a liquid crystal layer comprising cholesteric liquid crystal material; and i) a flexible back substrate and an elastic material layer; or ii) an elastic back substrate. The flexible front substrate is located more proximal to a person viewing the liquid crystal display device than is the liquid crystal layer. The i) flexible back substrate and the elastic material layer; and ii) the elastic back substrate, when present, are located in back of the liquid crystal layer. Pressure applied on the flexible front substrate changes a texture of the cholesteric liquid crystal material which displays an image. The pressure is from at least one of: a) impact of a projectile, a corresponding image including an impact mark; b) a writing instrument, a corresponding image including writing or drawing; and c) an imprinting instrument, a corresponding image including an imprinted image. Application of an electric field to the liquid crystal layer or flexing of the liquid crystal layer erases at least a portion of the image.

In some aspects of the disclosure i) the flexible back substrate and elastic material layer; and ii) the elastic back substrate, are each referred to as “an elastic back structure.” For the liquid crystal display device to form images, at least part of the elastic back structure, for example, at least part of the flexible back substrate and the elastic material layer, locally deforms under the applied pressure. On the other hand, the BOOGIE BOARD® writing tablet is designed for applying pressure to the writing surface that is supported by a rigid back structure while moving a hard pointed stylus or a fingernail to traverse across the writing surface so as to form an image by writing or drawing. The cholesteric liquid crystal display writing tablets of the prior art employ a rigid case or are used with a rigid back structure, which prevents substantial local deformation of the back substrate. The liquid crystal display device of this disclosure can form images upon applying pressure on the flexible front substrate, as a result of the design of the elastic back structure including optional back casing. The elastic back structure makes the liquid crystal display device elastic. The term “elastic” as used herein has its conventional meaning. The terms “elastic material layer,” “elastic back substrate,” and “makes the liquid crystal display device elastic” means the ability of at least a part of a locally deformed elastic material layer, elastic back substrate or liquid crystal display device, respectively, to return to its original shape and size when the forces causing the local deformation are removed.

In the displays of all embodiments of this disclosure and all features described herein, reference to “a projectile” can include “a soft projectile” and “a soft fast projectile.” Any propulsion system used in a toy gun may be used to fire the projectile, including a hand launch. The projectile has a softness that is affected by the material of which it is comprised. The impacting portion of the projectile may include portions of different softness and rigidity. The shape and size of the mark left on the liquid crystal display device is dependent on the accuracy of the shot, the shape of the projectile, the design of the elastic back structure, the rigidity of the casing, and softness, force, mass and velocity of the projectile. When this disclosure refers to optional features it means the feature can be present or not. When reference is made in this disclosure to “applying pressure on the [or said] flexible front substrate,” although direct contact among the projectile, the writing instrument or the imprinting instrument, and the flexible front substrate, is one option, no such direct contact is required. As will be understood by those of ordinary skill in the art in view of this disclosure, pressure can be applied on the flexible front substrate without direct contact with it.

In all embodiments herein, a person having ordinary skill in the art would realize that the liquid crystal display device is not limited by the presence or absence of a polymer layer or other material in the liquid crystal layer, by material present or absent between the liquid crystal layer and the back electrically conductive layer, by material present or absent between the back electrically conductive layer and the flexible back substrate, by material present or absent between the back electrically conductive layer and the elastic material layer, by material present or absent between the back electrically conductive layer and the elastic back substrate, by the presence or absence of a material near the outermost surfaces of the flexible back substrate, or by the presence or absence of a material near the outermost surface of the back casing, and covers all variations thereof. When the disclosure refers to the “back surface of the liquid crystal display device”, it permits other layers to be disposed on or formed on the back most liquid crystal display device component shown in the drawings or described (e.g., between the back most of the elastic back substrate, the elastic material layer and the back casing, and the back surface of the liquid crystal display device). The drawings showing the outermost surface of the front substrate as the front surface of the liquid crystal display device or the outermost surface of the back casing as the back surface of the liquid crystal display device, for example, are merely examples and should not be interpreted to limit the disclosure to these exact features.

The following refers to more specific features that can be used with the general aspect of the disclosure in any combination, and combined with any features of the Detailed Description.

Feature 1: The liquid crystal display device of the general embodiment wherein at least a portion of the elastic material layer and at least a portion of the elastic back substrate, when present, have a Shore 00 hardness not greater than at least one of the following values: 90, 75, 60, 50, 40, 30, 20, 10.

Feature 2: The liquid crystal display device of the general embodiment wherein the elastic material layer and the elastic back substrate, when present, comprise at least one of vinyl sheets with Shore A hardness less than 80, bubble wrap, neoprene, synthetic flash spun high-density polyethylene fibers, fleece fabric, carpeting material, elastomer sheets, clothing fabric, canvas, a layer of cotton balls, a sheet of wool, foam and bubble wrap.

Feature 3: The liquid crystal display device of the general embodiment wherein the elastic material layer and the elastic back substrate, when present, comprise a plurality of first regions comprising a first material and a plurality of second regions comprising a second material, wherein the first material has different elasticity than the second material.

Feature 4: The liquid crystal display device of the general embodiment wherein the elastic material layer and the elastic back substrate, when present, comprise a plurality of first regions comprising a first material and a plurality of second regions comprising a second material, wherein the first material has: i) different mechanical properties other than elasticity; or ii) different thickness, than the second material.

Feature 5: The liquid crystal display device of the general embodiment wherein the elastic material layer and the elastic back substrate, when present, comprise a plurality of first regions comprising a first material and a plurality of second regions comprising a second material, wherein the first material has different color or opacity, or other optical properties, than the second material.

Feature 6: The liquid crystal display device of the general embodiment comprising a back material layer located in back of: i) the flexible back substrate and the elastic material layer; and ii) the elastic back substrate, when present, wherein the back material layer comprises an imprinting structure forming a pattern, design or image that is adapted to be imprinted on the liquid crystal layer as a result of the pressure applied on the flexible front substrate.

Feature 7: The liquid crystal display device of Feature 6 wherein the back material layer is replaceable.

Feature 8: The liquid crystal display device of the general embodiment comprising a back material layer located in back of: i) the flexible back substrate and the elastic material layer; and ii) the elastic back substrate, when present, wherein the back material layer comprises a body portion that is rigid or flexible and cutouts in the portion body forming a pattern, design or image that is adapted to be imprinted on the liquid crystal layer as a result of the pressure applied on the flexible front substrate.

Feature 9: The liquid crystal display device of Feature 6 comprising a light absorbing layer that absorbs light passing through the liquid crystal layer and hides the imprinting structure in an initial state of the liquid crystal display device.

Feature 10: The liquid crystal display device of the general embodiment comprising at least one graphics layer or patterned layer disposed on or inside the liquid crystal display device that is visible to a person viewing the liquid crystal display device, wherein the at least one graphics layer or the patterned layer is optionally replaceable from the liquid crystal display device and optionally includes an image that can be erased by wiping.

Feature 11: The liquid crystal display device of Feature 10 wherein the at least one graphics layer or patterned layer gives the liquid crystal display device features of a target to which a person can aim the projectile.

Feature 12: The liquid crystal display device of the general embodiment comprising a front graphics layer near the flexible front substrate, wherein the front graphics layer includes an opaque portion and a transparent portion or a semitransparent portion, wherein the opaque portion masks the liquid crystal layer underlying the opaque portion and wherein marks are formed in the liquid crystal layer underlying the transparent portion or the semitransparent portion by the applied pressure and are visible on the liquid crystal display device.

Feature 13: The liquid crystal display device of the general embodiment comprising a front graphics layer near the flexible front substrate, wherein the front graphics layer includes a body portion comprising a flexible or rigid material and cutouts formed in the body portion, wherein the cutouts contain air, fluid or a soft material, and the body portion prevents marking of the liquid crystal layer underlying the body portion.

Feature 14: The liquid crystal display device of the general embodiment comprising the projectile as a toy which is a ball, a dart, a bullet or an arrow comprising at least one of soft polymer, foam, a liquid and a gel, or is a liquid jet, a compressed volume of liquid, or an air jet.

Feature 15: The liquid crystal display device of the general embodiment wherein the image includes a mark inside of which the cholesteric liquid crystal material has a first texture that is one of a planar texture, a gray scale texture or a focal conic texture and outside the mark the cholesteric liquid crystal material has a different second texture that is one of the planar texture, the gray scale texture or the focal conic texture.

Feature 16: The liquid crystal display device of the general embodiment wherein the impact mark is in the form of a splatter.

Feature 17: The liquid crystal display device of the general embodiment wherein the writing instrument includes flesh of a finger, a blunt instrument other than the flesh of a finger, a foot, a soft polymer, foam, a liquid jet, a compressed volume of liquid, an air jet or a pointed stylus.

Feature 18: The liquid crystal display device of the general embodiment wherein the imprinting instrument includes a stylus that is pointed or blunt, a finger, polymer, foam, a roller, a cloth, a liquid jet, a compressed volume of liquid, or an air jet.

Feature 19: The liquid crystal display device of the general embodiment comprising a back casing in back of the elastic material layer and the elastic back substrate, when present, that is rigid or flexible, further comprising an optional side casing and an optional front bezel pressing against a perimeter of the flexible front substrate.

Feature 20: The liquid crystal display device of the general embodiment comprising electrically conductive layers between which the liquid crystal layer is disposed, and erase electronics adapted to apply a voltage waveform to said electrically conductive layers that applies the electric field to the liquid crystal layer to erase at least a portion of the image and initialize the liquid crystal display device for making a new image.

Feature 21: Multiple of the liquid crystal display devices of Feature 20 which are all electrically connected to common erase electronics that applies the electric field so as to carry out erasing of at least a portion of the image of the liquid crystal display devices independently or in combination.

Feature 22: The multiple liquid crystal display devices of Feature 21 wherein the erase electronics includes at least one actuator that independently applies an erase voltage waveform to the electrically conductive layers of each of at least two of the liquid crystal display devices.

Feature 23: The multiple liquid crystal display devices of Feature 21 wherein the erase electronics includes at least one actuator that independently applies an erase voltage waveform to the electrically conductive layers of each of the liquid crystal display devices, and that applies erase voltage waveforms to the electrically conductive layers of at least two of the liquid crystal display devices in combination.

Feature 24: Fabric on which the liquid crystal display device of the general embodiment is attached or to which the liquid crystal display device is integrally formed.

Feature 25: The liquid crystal display device of the general embodiment wherein the flexible front substrate is transparent, semi-transparent, opaque or colored.

In a second embodiment of the disclosure a liquid crystal display device comprises: a flexible front substrate; a liquid crystal layer comprising cholesteric liquid crystal material; and elastic back structure that makes the liquid crystal display device elastic. The flexible front substrate is located more proximal to a person viewing the liquid crystal display device than is the liquid crystal layer. At least a part of the elastic back structure is located in back of the liquid crystal layer. Pressure applied on the flexible front substrate changes a texture of the cholesteric liquid crystal material which displays an image. Application of an electric field to the liquid crystal layer or flexing of the liquid crystal layer erases at least a portion of the image.

Feature 26: The liquid crystal display device of the second embodiment wherein the elastic back structure comprises a flexible back substrate and an elastic material layer located in back of the flexible back substrate, which are located in back of the liquid crystal layer.

Feature 27: The liquid crystal display device of Feature 26 wherein the elastic material layer comprises a plurality of first regions comprising a first material and a plurality of second regions comprising a second material, wherein the first material has different elasticity than the second material.

Feature 28: The liquid crystal display device of the second embodiment wherein the elastic back structure comprises an elastic back substrate that is located in back of the liquid crystal layer.

Feature 29: The liquid crystal display device of Feature 28 wherein the elastic back substrate comprises a plurality of first regions comprising a first material and a plurality of second regions comprising a second material, wherein the first material has different elasticity than the second material.

Feature 30: The liquid crystal display device of the second embodiment wherein the elastic back structure comprises a flexible back substrate and a back material layer located behind the flexible back substrate, which are located in back of the liquid crystal layer, the back material layer comprising an imprinting structure forming a pattern, design or image that is adapted to be imprinted on the liquid crystal layer as a result of the pressure applied on the flexible front substrate.

Feature 31: The liquid crystal display device of Feature 30 wherein the back material layer is replaceable.

Feature 32: The liquid crystal display device of Feature 30 comprising a light absorbing layer that absorbs light passing through the liquid crystal layer and hides the imprinting structure in an initial state of the liquid crystal display device.

Feature 33: The liquid crystal display device of the second embodiment wherein the elastic back structure comprises a flexible back substrate in back of the liquid crystal layer and a casing that is rigid or flexible having a shape of a drum frame that encases portions of a front, a back and sides of the liquid crystal display device.

Feature 34: The liquid crystal display device of the second embodiment comprising a front graphics layer near the flexible front substrate, wherein the front graphics layer includes an opaque portion and a transparent portion or a semitransparent portion, wherein the opaque portion masks the liquid crystal layer underlying the opaque portion and wherein marks are formed in the liquid crystal layer underlying the transparent portion or the semitransparent portion by the applied pressure and are visible on the liquid crystal display device.

Feature 35: The liquid crystal display device of the second embodiment comprising a front graphics layer near the flexible front substrate, wherein the front graphics layer includes a body portion comprising a flexible or rigid material and cutouts formed in the body portion, wherein the cutouts contain air, fluid or a soft material, and the body portion prevents marking of the liquid crystal layer underlying the body portion.

Feature 36: The liquid crystal display device of the second embodiment wherein the elastic back structure is constructed and arranged to enable a projectile, flesh of a finger or a blunt instrument other than the flesh of a finger, which applies the pressure on the flexible front substrate, to form the image.

Feature 37: The liquid crystal display device of the second embodiment wherein at least a portion of the elastic back structure has a Shore 00 hardness not greater than at least one of the following values: 75, 60, 50, 40, 30, 20, 10.

Feature 38: The liquid crystal display device of the second embodiment wherein the elastic back structure comprises at least one of vinyl sheets with Shore A hardness less than 80, bubble wrap, neoprene, synthetic flash spun high-density polyethylene fibers, fleece fabric, carpeting material, elastomer sheets, clothing fabric, canvas, a layer of cotton balls, a sheet of wool, foam and bubble wrap.

It should be understood that the above Summary of the Disclosure describes embodiments of the disclosure in broad terms while the following Detailed Description describes embodiments of the disclosure more narrowly and presents specific embodiments that should not be construed as necessary limitations of the invention as broadly defined in the claims. Many additional features, advantages and a fuller understanding of the disclosure will be had from the accompanying drawings and the Detailed Description that follows.

### BRIEF DESCRIPTION OF THE DRAWINGS

FIGS. 1A-F show front views of variations of two liquid crystal display devices constructed according to the disclosure effective to show splatter marks or more precise marks, respectively, and show that for both liquid crystal display devices, the selection of locations of graphics layers or patterned layers on or inside it affects whether the graphics or pattern are obscured by the marks on the liquid crystal layer, or not;

FIG. 2 is a perspective view of a liquid crystal display device of the present disclosure showing an image formed by writing or drawing;

FIG. 3 is a side view of a liquid crystal display device of the disclosure having an elastic material layer;

FIG. 4 is a side view of a liquid crystal display device having an elastic material layer including first regions comprising a first material and second regions comprising a second material, wherein the first material and the second material have different characteristics;

FIG. 5A is a perspective view of a liquid crystal display device constructed according to the disclosure including a display and a replaceable material layer having a pattern, design or an image that is imprinted on the liquid crystal layer; FIG. 5B shows how the imprinted image can appear on the liquid crystal display device;

FIG. 6 is a schematic view showing multiple liquid crystal display devices made according to any embodiment of the disclosure that are erased independently or in various combinations together with common erase circuitry; and

FIG. 7 is a side view of a liquid crystal display device constructed according to the disclosure including a casing in a shape of a drum frame that encases portions of a front, a back and optionally sides of the liquid crystal display device.

The drawings are not drawn to scale.

### DETAILED DESCRIPTION

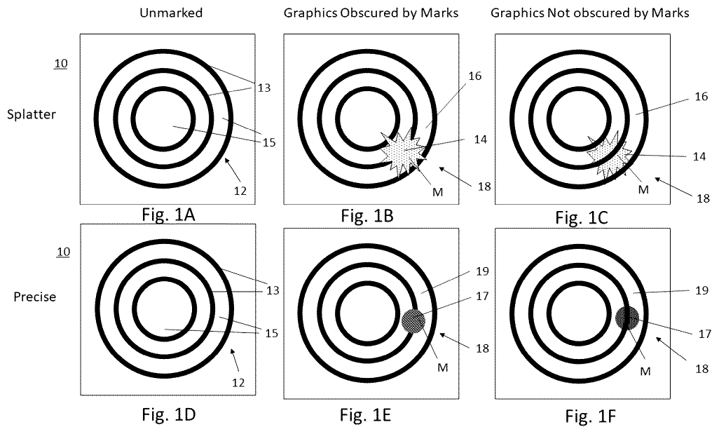

Turning now to various embodiments of this disclosure where like reference numerals represent like parts throughout the several views of the drawings, FIGS. 1A-F describe operation of liquid crystal display devices 10. An image 18 is made by applying pressure on the flexible front substrate so as to make a mark by impact of a projectile, using a writing instrument or using an imprinting instrument. Inside the mark the cholesteric liquid crystal material has a first texture that is one of a planar texture, a gray scale texture or a focal conic texture and outside the mark the cholesteric liquid crystal material has a different second texture that is one of the planar texture, the gray scale texture or the focal conic texture. FIGS. 1A-1F show that the impact of projectiles forms impact marks M in the liquid crystal layer. These figures display a graphics layer 12 forming an image of a target, at different locations in the liquid crystal display device. Throughout this disclosure a person V viewing the liquid crystal display device sees an image on it in a direction of the arrow of the person V's line of sight (e.g., see person V in the figures and line of sight direction represented by the arrows in the figures).

In a particular aspect of a liquid crystal display device of the disclosure (e.g., bright marks having dark surroundings), the cholesteric liquid crystal material of a liquid crystal layer is adapted to have an initial state that is generally transparent, referred to as the focal conic texture. The liquid crystal display device is designed so that a local deformation caused by applying pressure on the flexible front substrate, deforms the flexible front substrate, the liquid crystal layer and at least a part of the elastic back structure, changing at least a portion of the cholesteric liquid crystal texture from the initial generally transparent focal conic texture 16 of the viewing area to the light reflective planar texture 14 inside a mark to form the image 18 comprised of a mark in the light reflective planar texture 14 having surroundings outside the mark in the focal conic texture 16. The pressure can be applied, for example, by a projectile, a writing instrument or an imprinting instrument. The cholesteric liquid crystal material can be tuned as known in the art so to produce a certain reflective color. The target formed by the graphics layer 12 is also part of the image 18 that is displayed on the liquid crystal display device. The mark is formed on the liquid crystal layer only by applying pressure, without needing any voltage to be applied at the time when the pressure is applied. A voltage is only used to erase at least a portion of the image. An optional light absorbing layer or light absorbing back surface at least partially absorbs light passing through the liquid crystal layer and can be opaque or semitransparent. The light absorbing layer or light absorbing back surface provides contrast with the reflective mark formed by the liquid crystal layer, enabling at least one image to be viewed on the liquid crystal layer.

In a non-limiting example, the target image (FIGS. 1A-1C) formed by the graphics layer 12 includes target circles 13 made of black opaque ink having target background 15 made of semitransparent blue ink. A light absorbing layer in back of the liquid crystal layer and the graphics layer 12 is black. The impact of projectiles forms the impact marks M in the liquid crystal layer. The semitransparent blue ink of the target background 15 of the graphics layer 12, aligned with areas of the surroundings in the focal conic texture 16 around the mark M and darkened by the black light absorbing layer, contrasts with the brighter semitransparent blue ink target background 15 aligned with areas of the reflective texture planar texture 14 inside the impact mark M (FIGS. 1B-1C).

In another aspect of a liquid crystal display device of the disclosure (e.g., dark marks having bright surroundings as disclosed in U.S. Pat. No. 11,409,175 for Dark Writing, which is incorporated herein by reference in its entirety) the cholesteric liquid crystal material of the liquid crystal layer is adapted to have its initial state in the light reflective planar texture 19 so that in the front view the screen or viewing surface of the liquid crystal display device appears entirely as a reflective color determined by the pitch of the cholesteric liquid crystal material in combination with the reflection spectra of the display layers and optional light absorbing layer. The liquid crystal display device 10 is designed so that a local deformation of the flexible front substrate caused by applying pressure on the flexible front substrate, deforms the flexible front substrate, the liquid crystal layer and at least a part of the elastic back structure, changing at least a portion of the cholesteric liquid crystal texture from the initial, light reflective planar texture 19 to a transmissive texture 17 inside a mark in the liquid crystal layer. The pressure can be applied, for example, by a projectile, a writing instrument or an imprinting instrument. The surroundings outside of the mark in the liquid crystal layer where pressure was not applied on the flexible front substrate, are comprised of one or more regions of the light reflective planar texture 19 of the liquid crystal material. The transmissive texture 17 inside the mark and the surroundings in the light reflective planar texture 19 outside the mark form parts of the image 18. The target formed by the graphics layer 12 is also part of the image 18 that is displayed on the liquid crystal display device. The mark is formed on the liquid crystal layer only by applying pressure, without needing any voltage to be applied at the time when the pressure is applied. A voltage is only used to erase a portion of the image. The transmissive texture 17 part of the image 18 created by the local deformation inside the mark remains even after the deformation is completed, allowing more ambient light to go through the region of the deformation, i.e., the region of liquid crystal comprising the mark, than through the surroundings outside the mark in the light reflective planar texture 19 where pressure was not applied. Light passing through the transmissive texture 17 is absorbed and/or reflected by the optional light absorbing layer.

In a non-limiting example, the target image (FIGS. 1D-1F) formed by the graphics layer 12 includes the target circles 13 made of black opaque ink having the target background 15 made of semitransparent blue ink. A light absorbing layer in back of the liquid crystal layer and the graphics layer 12 is black. The impact of projectiles forms the impact marks M in the liquid crystal layer. The semitransparent blue ink of the target background 15 of the graphics layer 12, aligned with areas of the surroundings in the light reflective planar texture 19 around the mark M, contrasts with the darker semitransparent blue ink target background 15 aligned with areas of the transmissive texture 17 inside the impact mark M (FIGS. 1E,1F) that are darkened by the black light absorbing layer.

In one aspect, the image 18 includes the impact mark M formed by a splatter of the cholesteric liquid crystal material in the liquid crystal layer (see FIGS. 1B, 1C). There can be one impact mark M, a few impact marks M or a plurality of impact marks M peppering the viewing area, which affects the image 18 seen by the person V viewing the liquid crystal display device 10. FIG. 1B shows how the liquid crystal display device 10 looks after impact from a projectile illustrating a splattered form of the impact mark M where the graphics layer 12 is near a back of the liquid crystal display device in which the graphics are obscured by the impact marks M. The impact of projectiles forms the impact marks M in the liquid crystal layer, which are in front of the graphics/patterned material layer that is near the back of the liquid crystal display device. FIG. 1C shows how the liquid crystal display device looks after impact of a projectile where the graphics layer 12 is near a front of the liquid crystal display device in which the graphics/patterned material layer is not obscured by the impact marks M. The impact of projectiles forms the impact marks M in the liquid crystal layer, which are behind the graphics/patterned material layer that is near a front of the liquid crystal display device.

FIGS. 1E-F show an image of a target formed by the graphics layer 12 and illustrating circular impact marks M that are more representative of the shape of the impacting surface of the projectile compared to the impact marks M of FIGS. 1B and 1C. The liquid crystal display device of FIGS. 1D-F is similar to that of FIGS. 1A-C. However, a difference is the material and thickness of the elastic material layer or other variation in the liquid crystal display device that enables making more precise impact marks. FIG. 1E shows how the liquid crystal display device looks after impact from a projectile where the graphics layer 12 is near a back of the liquid crystal display device in which the graphics are obscured by the impact marks M. The impact marks M are formed in the liquid crystal layer in front of the graphics layer 12. FIG. 1F shows how the liquid crystal display device looks after impact from a projectile where the graphics layer/patterned material layer 12 is near a front of the liquid crystal display device in which the graphics are not obscured by the impact marks M. The projectile hits the front surface that forms the impact marks M in the liquid crystal layer, which is behind the graphics/patterned material layer that is near a front of the liquid crystal display device.

A size and shape of a local impact mark M on the front surface is affected by the size and shape of the portion of the projectile impacting the front surface (e.g., a tip of a soft dart or a soft ball), a velocity of the projectile and material properties (e.g., softness) of the projectile and the design of the elastic material layer. The shape of the impact mark M is influenced by the design of the elastic material layer. For example, a softer, thicker elastic material layer will create a splatter impact mark M as shown in FIGS. 1B and 1C and a harder and thinner elastic material layer will create a more precise impact mark M like those shown in FIGS. 1E and 1F. In one example, the projectile has a rounded tip making the impact, for example, a soft foam dart or a soft foam bullet. The projectile may be in the shape of a soft foam ball. The projectile may also have a flat end making the impact, such as is present in a foam stick-shaped projectile (e.g., a soft cylinder, a soft object having a plus-shape, honeycomb shape or other geometric shape in cross-section). The projectile may have a more pointed end making the impact such as a soft arrow. As a particular feature, in all aspects of the disclosure the projectile can travel fast, for example, at a velocity at which a projectile is fired from a toy gun (e.g., shooting with compressed air). The projectile may be comprised of different materials along its length or diameter, for example, a soft dart with a soft polymer tip and a different material(s) in its body. The projectile may include gel or water in its body. The projectile may be in the form of a jet of air or a jet of water, or a compressed volume of water. A stylus for writing on a liquid crystal writing tablet is considered to be hard, not a soft object, and is not a soft projectile.

In any of the embodiments of the disclosure the liquid crystal display device 10 can comprise the graphics layer 12 showing a design, a pattern or an image disposed on or inside the liquid crystal display device 10 (e.g., the image of a target shown in FIGS. 1A-1F). There can be none, one, or more than one graphics layer 12 or color layer at any location in or on in the liquid crystal display device. The graphics layer 12 can be, for example, print, a sticker, or rigid or flexible patterned material. In any of the embodiments the graphics layer 12 can be at least one of the following: opaque; semitransparent; cover the whole viewing area where marks can be made or only a portion of the viewing area; can be patterned or not. The image 18 of the liquid crystal display device 10 is comprised of the marks (e.g., impact marks M) resulting from the local deformation of the flexible front substrate that causes the cholesteric liquid crystal material to change its texture, and optionally at least one graphics layer 12.

The liquid crystal display device can include at least one front graphics layer 12 located near the flexible front substrate. In one aspect, the front graphics layer 12 includes a body portion (first region) that is rigid or flexible and cutouts in the body portion containing air, fluid or a soft material (second region), wherein the body portion prevents marking of the liquid crystal layer underlying the body portion and wherein the liquid crystal layer underlying the cutouts is marked by the applied pressure. The material in the cutouts is transparent or semitransparent. The front graphics layer 12 may include more than one layer. The front graphics layer 12 has at least one of the following characteristics: being replaceable; being able to be written on with marker or the like and being wipeable; displaying graphics (e.g., a print or label of graphics) and/or including graphics on or formed in it (e.g., a front layer in which the cutouts in it form a pattern, design or image). For example, the front graphics layer can have a grid pattern of (e.g., 1 mm) thick black ABS bonded to the flexible front substrate. In one feature, the front casing 54 could extend in the viewing area and function as the front graphics layer: it could be partially rigid and include a pattern, design or image. Another example forms the image of stars in a rigid graphics layer 12 (e.g., a rigid acrylic layer forming a black background) with the stars being formed by cutouts in the rigid acrylic layer containing air or an optional colored soft material inside the stars (e.g., showing a color from planar texture reflection of the liquid crystal layer in areas underlying the star-shaped cutouts where pressure is applied, with or without the optional colored soft material inside the stars). Another example resembles the image of a target of FIGS. 1A-1F (cutouts in rigid material forming a target image of graphics layer 12) wherein the target background is formed by annular cutouts in between interconnected, opaque dark target circles of rigid material, so that an image is formed when projectiles hit inside the annular cutouts in between the opaque dark target circles. In another example referring to FIGS. 1A-F, the image of the target could be a print or label of a target as the graphics layer 12 attached to the flexible front substrate, in which the target circles are formed of opaque ink and the target background is formed of a semitransparent color (e.g., blue) ink. The opaque ink portion masks the liquid crystal layer underlying the opaque ink portion so that marks formed in the liquid crystal layer underlying the opaque ink portion are hidden. Marks are formed in the liquid crystal layer underlying the semitransparent ink portion by the applied pressure and are visible on the liquid crystal display device.

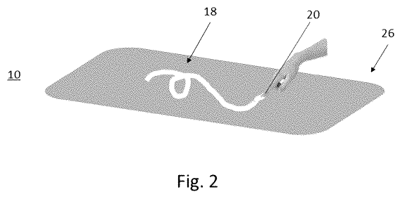

Referring to FIG. 2, a liquid crystal display device 10 of the present disclosure displays an image 18 formed by writing or drawing by applying pressure with a writing instrument 20 on the flexible front substrate 26. In this example the writing instrument 20 is the flesh of a person's finger. This causes the local deformation of the liquid crystal layer and at least a part of the elastic back structure and changes the texture of the cholesteric liquid crystal material to form an image 18 of writing or drawing. The image 18 formed of writing or drawing includes marks that can be longer and more continuous in comparison to the image 18 formed by individual impact marks M. The writing instrument 20 includes the flesh of a person's finger, a blunt instrument other than the flesh of a person's finger (e.g., a stylus with a blunt tip that is rounded and not pointed), a foot, a soft polymer, foam, a liquid jet, a compressed volume of liquid, an air jet or a pointed stylus. For example, the liquid crystal display device could be written on by stepping on it.

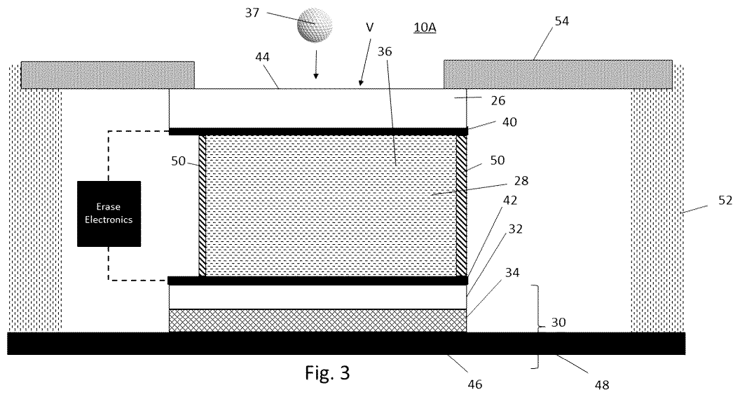

Referring to FIG. 3, a liquid crystal display device 10A that is erasable, comprises a flexible front substrate 26 and a liquid crystal layer 28. Also included in the liquid crystal display device are a flexible back substrate 32 and an elastic material layer 34 (e.g., an elastic back structure 30). The liquid crystal layer 28 comprises cholesteric liquid crystal material 36. The flexible front substrate 26 is located more proximal to a person V viewing the liquid crystal display device 10A than is the liquid crystal layer 28. The elastic back structure 30 is located in back of the liquid crystal layer 28. Pressure applied on the flexible front substrate 26 changes a texture of the cholesteric liquid crystal material 36 which displays the image. The applied pressure is from at least one of: i) impact of a projectile 37, a corresponding image including an impact mark M (e.g. FIGS. 1B, 1C, 1E, 1F; FIG. 3); and ii) a writing instrument 20, a corresponding image including writing or drawing (e.g., FIG. 2). In one example, FIG. 3 shows the display 10A in the process of being marked by a projectile 37.

The flexible front substrate 26 and the flexible back substrate 32 are spaced apart from each other. An optional front electrically conductive layer 40 and an optional back electrically conductive layer 42 can be used and are spaced apart from each other. The liquid crystal layer 28 is disposed between the optional front and back electrically conductive layers 40, 42. The optional front electrically conductive layer 40 is disposed between the flexible front substrate 26 and the liquid crystal layer 28. The optional back electrically conductive layer 42 is disposed between the liquid crystal layer 28 and the flexible back substrate 32.

A front surface 44 of the liquid crystal display device 10A is located near the flexible front substrate 26, for example, the outermost surface disposed or formed on the flexible front substrate 26. The front surface 44 of the liquid crystal display device is, in particular, located on the flexible front substrate. A back surface 46 of the liquid crystal display device 10A is farthest back in the liquid crystal display device. In all embodiments of the disclosure, examples of layers that can be formed on the flexible front substrate 26 are: an anti-glare coating, a scratch resistant coating, a graphic print or graphics coating, and a coating giving the liquid crystal display device impact resistance. The elastic back structure 30 is adapted to enable pressure applied on the flexible front substrate 26 (e.g., a projectile traveling at high velocity as in the case of a soft dart shot from an air pressurized toy gun) to change a texture of the cholesteric liquid crystal material 36, which displays an image. The liquid crystal display device's sensitivity to the applied pressure comes from making the liquid crystal display device 10A elastic, e.g., making the elastic back structure 30 move when the pressure is applied and return to its original position when the pressure is removed.

An optional back casing 48 that is rigid or flexible is located near or forms the back surface 46 of the liquid crystal display device 10A and, if used, is part of the elastic back structure 30. In all embodiments of this disclosure the flexible front substrate 26 and/or the flexible back substrate 32, independently can be only partially flexible. In all embodiments of this disclosure an optional light absorbing layer absorbs light passing through the liquid crystal layer and is disposed in back of the liquid crystal layer 28 relative to a direction of a person V viewing the liquid crystal display device. For example, in FIG. 3 the elastic material layer 34 and/or the optional back casing 48 may function as a light absorbing layer. The optional light absorbing layer can be added to the liquid crystal display device 10A shown in FIG. 3. In all embodiments of the disclosure, even if not seen in the drawings, the liquid crystal display device may include an optional seal 50 in a shape of a frame around a perimeter that confines the cholesteric liquid crystal material 36 inside the perimeter.

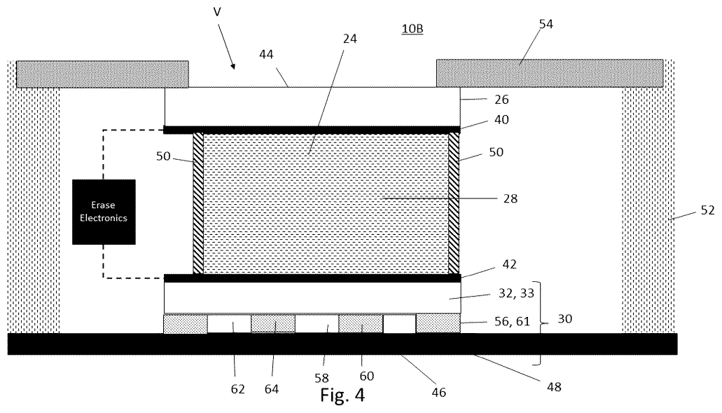

Although the liquid crystal display device 10A shown in FIG. 3 includes the flexible back substrate 32 and the elastic material layer 34, in other options (not shown) the elastic material layer 34 (and elastic material layer 56 of FIG. 4 discussed below) can be a standalone layer functioning as an elastic back substrate, with the separate flexible back substrate 32 being omitted. An optional side casing 52 is disposed along sides of the liquid crystal display device 10A and an optional front bezel 54 presses against a perimeter of the flexible front substrate 26. The back casing 48, side casing 52, and bezel 54 can be one or separate pieces. The elastic material layer 34 is optionally patterned. The elastic material layer 34 and the optional back casing 48 are located near the back surface 46 of the liquid crystal display device 10A. For example, the back surface 46 of the liquid crystal display device is an outermost surface disposed or formed on the elastic material layer 34 or the optional back casing 48. The optional back casing 48 is located more proximal to the back surface 46 of the liquid crystal display device 10A than is the elastic material layer 34. The pressure applied on the flexible front substrate 26 causes local deformation of the flexible front substrate 26, the liquid crystal layer 28, the flexible back substrate 32, the elastic material layer 34 and optionally the back casing 48 if flexible. The optional front and back electrically conductive layers 40, 42 and the optional light absorbing layer also locally deform in response to the impact. The local deformation of the elastic material layer 34 pushes against the optional back casing 48. The local deformation of the components of the liquid crystal display device 10A and pushing against the optional back casing 48 in response to the applied pressure, changes a texture of the cholesteric liquid crystal material 36 to form an image. The erase electronics can be used to apply the voltage waveform that changes the texture of the cholesteric liquid crystal material 36 to the initial texture, thereby erasing at least a portion of the image on the liquid crystal display device as well as initializing the liquid crystal display device for making the next image. The liquid crystal display device can be flexed to erase at least a portion of the image as well as initializing the liquid crystal display device for making the next image.

At least a portion of the elastic material layer 34 can include elastic material that is at least one of the following: foam (e.g., packing foam), vinyl sheets with shore A hardness less than 80, bubble wrap, neoprene, DuPont Tyvek® synthetic flash spun high-density polyethylene fibers, fleece fabric, carpeting material, elastomer sheets, clothing fabric, canvas, a layer of cotton balls, and a sheet of wool (e.g., 3 mm thick). A separating layer and/or the flexible back substrate 32 provides a physical separation between the elastic material layer 34 and the liquid crystal layer 28 that is effective when using certain elastic materials, for example, fleece fabric, cotton balls or wool. The elastic material layer 34 can be attached to the flexible back substrate 32 using any manner of attachment including spray adhesive, rubber cement, pressure sensitive adhesive, thermal adhesive, pins, staple or safety pins.

FIG. 4 shows an embodiment in which the liquid crystal display device 10B is similar to the liquid crystal display device 10A of FIG. 3. A difference is that instead of elastic material layer 34 it includes an elastic material layer 56 that includes a plurality of regions 58, 60 comprising a first material 62 and a second material 64, respectively, and an optional third material (not shown) that in one aspect have different elasticities than each other. In the plurality of regions 58, 60 the first material 62, the second material 64 and the optional third material, can have different: mechanical properties besides elasticity; thickness; or opacity, color, or other optical properties, than each other, and combinations thereof. The plurality of regions 58, 60 can be patterned or not patterned (e.g., randomly arranged). Although the regions 58, 60 are shown as having uniform size and shape, each region could be a different size and/or shape than one or more than one of the other regions. There could be as little as two regions, one region 58 and one region 60. In one aspect of the liquid crystal display device 10B, the elastic back structure 30 includes the flexible back substrate 32, the elastic material layer 56 and the optional back casing 48. The elastic material layer 56 and the optional back casing 48 are located near the back surface 46 of the liquid crystal display device 10B. For example, the back surface 46 of the liquid crystal display device is an outermost surface disposed or formed on the elastic material layer 56 or the optional back casing 48. The optional back casing 48 is located more proximal to the back surface 46 of the liquid crystal display device 10B of FIG. 4 than is the elastic material layer 56. The pressure applied on the flexible front substrate 26 causes local deformation of the flexible front substrate 26, the liquid crystal layer 28, the flexible back substrate 32, at least part of the elastic material layer 56 and optionally the back casing 48, if flexible. The optional front and back electrically conductive layers 40, 42 and the optional light absorbing layer also locally deform in response to the applied pressure. The local deformation of the elastic material layer 56 pushes against the optional back casing 48. The local deformation of the components of the liquid crystal display device 10B and pushing against the optional back casing 48 in response to the applied pressure, changes a texture of the cholesteric liquid crystal material 36 to form an image. The erase electronics can be used to apply the voltage waveform that changes the texture of the cholesteric liquid crystal material 36 to the initial texture, thereby erasing at least a portion of the image on the liquid crystal display device as well as initializing the liquid crystal display device for making the next image. The liquid crystal display device can be flexed to erase at least a portion of the image as well as initializing the liquid crystal display device for making the next image.

In some designs, the elastic material layer 56 can have layers that are soft or alternating layers that are hard and soft. For example, in back of the flexible front substrate 26 and the liquid crystal layer 28, a soft elastic layer about 3 mm thick having a Shore 00 hardness of not more than at least one of the following: 90, 75, 70, 60, 50, 40, 30, 20, 10 can be placed on a 3 mm rigid ABS casing of Shore D hardness greater than 90. Thickness and hardness are coupled—for example, the elastic material layer 56 can have a Shore 00 hardness of 60 or less and is located between the flexible back substrate 32 and the optional back casing 48, which should have its thickness selected to allow the flexible back substrate to deform, enabling the projectile, the writing instrument or the imprinting instrument to form a mark. The softness and thickness of the elastic material layer 56 can be chosen so as to make the liquid crystal display device 10B more or less sensitive to the applied pressure. In all embodiments of the disclosure the elastic material layer 56 can be formed of at least one of the following: foam (e.g., packing foam), vinyl sheets with shore A hardness less than 80, bubble wrap, neoprene, DuPont Tyvek® synthetic flash spun high-density polyethylene fibers, fleece fabric, carpeting material, elastomer sheets, clothing fabric, canvas, a layer of cotton balls, and a sheet of wool (e.g., at least 3 mm thick). For some of these example materials, depending on the properties of the material of the elastic material layer 56, e.g., fleece fabric, cotton balls or wool, there would be a layer separating the liquid crystal layer 28 from the elastic material (e.g., cotton balls).

In an example wherein the liquid crystal display device 10B includes the flexible back substrate 32 and the elastic material layer 56, an elastic material (first material 62) is located in the cutouts of rigid material (second material 64). In another aspect, the first material 62 comprises a material of higher elasticity making up a larger portion of the surface area of the viewing area of the liquid crystal display device 10B while the second material 64 is embedded in the first material, is rigid and forms a shape. In one embodiment the elastic material layer 56 includes a pattern, design or an image, for example a rigid image, that is adapted to press against the liquid crystal layer 28 forming an imprint of the pattern, design or image on the liquid crystal layer as a result of the impact of the projectile, the pressure applied by the writing instrument, or the pressure applied by the imprinting instrument, including rubbing, on the flexible front substrate.

In another aspect, a liquid crystal display device 10B shown in FIG. 4 includes a flexible back substrate 32 and a back material layer 61 (which is flexible or rigid), instead of the elastic material layer 56. The back material layer 61 is located in back of the flexible back substrate 32. The back material layer 61 has a plurality of first regions 58 comprising a first material 62 and a plurality of second regions 60 comprising a second material 64. The plurality of first and second regions 58, 60 can be patterned or not patterned (e.g., randomly arranged). Although the first and second regions 58, 60 are shown as having uniform size and shape, each region could be a different size and/or shape than one or more than one of the other regions. There could be as little as two regions, one first region 58 and one second region 60. In one example of the back material layer 61, the first material 62 forms a body portion of first regions 58 and is rigid or flexible; and cutouts of second regions 60 formed in the body portion of the first regions 58, can comprise a second material 64 of air or a fluid. The cutouts or second regions 60 can form a desired shape, for example, a dinosaur, animal or images, including images from a children's game. In one embodiment the back material layer 61 includes a pattern, design or an image, for example a rigid image, that is adapted to press against the liquid crystal layer 28 forming an imprint of the pattern, design or image on the liquid crystal layer as a result of the impact of the projectile, the pressure applied by the writing instrument, or the pressure applied by the imprinting instrument, including rubbing, on the flexible front substrate. The applied pressure will form a bigger change in the reflectivity of the liquid crystal layer in second regions 60 (e.g., containing air or a fluid as second material 64) than in the first regions 58 that are formed of a rigid or flexible first material 62.

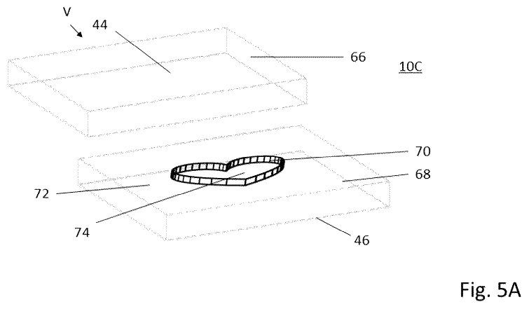

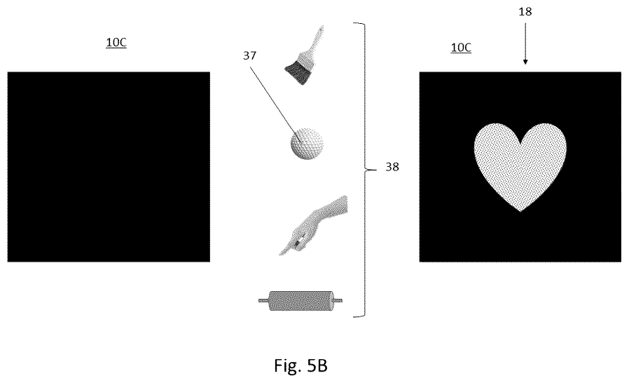

In the embodiment shown in FIGS. 5A and 5B, a liquid crystal display device 10C includes a display 66 and a replaceable material layer 68 having a pattern, design or an image that is imprinted on the liquid crystal layer in response to the pressure applied on the front surface 44 of the display 66. Parts of the liquid crystal display device 10C having the same name as parts of the liquid crystal display devices of FIG. 3 or 4 can be considered to be the same or similar as each other. The liquid crystal display device 10C includes the flexible front substrate, the flexible back substrate, the replaceable material layer 68 and the liquid crystal layer disposed between the flexible front substrate and the flexible back substrate. An imprinting structure 70 forms a pattern, design or image in this example as a rigid pattern, rigid design or rigid image in a shape of a heart. The flexible back substrate and the replaceable material layer 68 are located in back of the liquid crystal layer. The replaceable material layer 68 including the imprinting structure 70 in a pattern, design or image that can be imprinted on the liquid crystal layer of the display 66, can be separate from the display and used behind it without being permanently attached to it, enabling the display to be placed on a variety of patterns, design or images. The replaceable material layer 68 includes the imprinting structure 70, surroundings 72 around the imprinting structure 70 and a region 74 inside the imprinting structure 70.

The flexible front substrate is located near the front surface 44 of the liquid crystal display device 10C and the replaceable material layer 68 is located near the back surface 46 of the liquid crystal display device. The optional front electrically conductive layer is disposed between the flexible front substrate and the liquid crystal layer and the optional back electrically conductive layer is disposed between the liquid crystal layer and the flexible back substrate. Alternatively, the optional back electrically conductive layer is disposed between the liquid crystal layer and the replaceable material layer 68. The optional light absorbing layer can be used. The optional front and back electrically conductive layers and the optional light absorbing layer can both be part of the display 66 or the optional front electrically conductive layer can be part of the display 66 and the optional back electrically conductive layer can be part of and formed on a front of the replaceable material layer 68. The replaceable material layer 68 with embedded pattern is disposed, for example, behind the flexible back substrate and forms a back layer of the liquid crystal display device. The optional seal of elastomeric, adhesive or welded material in a shape of a frame can be disposed around a perimeter of the liquid crystal layer to contain the cholesteric liquid crystal material in the perimeter. Applying pressure on the flexible front substrate causes local deformation of the flexible front substrate, the liquid crystal layer and the flexible back substrate. This applied pressure also causes local deformation of at least a portion of the replaceable material layer 68 or deformation of an adjacent display component (e.g., the flexible back substrate) into a portion of the replaceable material layer 68. The optional front and back electrically conductive layers and the optional light absorbing layer also locally deform as a result of the applied pressure. The local deformation of the multiple layers as a result of the applied pressure causes a change in texture of the cholesteric liquid crystal material to form an image. The pattern, design or image of the imprinting structure 70 of the replaceable material layer 68, e.g., the rigid pattern, rigid design or rigid image, is able to be imprinted onto the liquid crystal layer upon the local deformation of the layers including the deformation into the replaceable material layer 68.

When the optional light absorbing layer is used that conceals the pattern, design or image of the imprinting structure 70, the pattern will remain hidden until the applied pressure starts to reveal it. On the other hand, without the light absorbing layer that conceals the pattern, design or image of the imprinting structure 70, for example, using a semitransparent back layer, the imprinting structure 70 can be seen by the viewer before pressure is applied on the flexible front substrate that changes the texture of the cholesteric liquid crystal material 36.

The following are examples of liquid crystal display device 10C design and operation in which the surroundings 72 are formed by a rigid material; the imprinting structure 70 is a cutout of a pattern, design or an image in the rigid material or a rigid insert in the surroundings 72 forming a pattern, design or an image; the region 74 includes air or a soft material; and there is no graphics layer 12 or color layer. If such a graphics layer 12 or color layer is used the appearance would change as understood by a person having ordinary skill in the art. When a dark initial state of the cholesteric liquid crystal material is used, if the pressure is applied to the entire viewing area the surroundings 72 will be dark and the heart shape of the imprinting structure 70 forming the region 74 inside the heart shape will be changed to be bright. When a bright initial state of the cholesteric liquid crystal material is used, if the pressure is applied to the entire viewing area the surroundings 72 will be bright and the heart shape of the imprinting structure 70 forming the region 74 inside the heart shape will be changed to be dark. In other examples of the design and operation of the liquid crystal display device 10C, the surroundings 72 can be formed of an elastic material, the imprinting structure 70 can be a rigid insert in the surroundings 72 and there is no graphics layer 12 or color layer. If such a graphics layer 12 or color layer is used the appearance would change as understood by a person having ordinary skill in the art. When a dark initial state of the cholesteric liquid crystal material is used, if the pressure is applied to the entire viewing area the surroundings 72 will be changed to be bright and the heart shape of the imprinting structure 70 forming the region 74 inside the heart shape will be dark. When a bright initial state of the cholesteric liquid crystal material is used, if the pressure is applied to the entire viewing area the surroundings 72 will be changed to be dark and the heart shape of the imprinting structure 70 forming the region 74 inside the heart shape will be bright.

Depending on the size of the tip of the projectile and the size of the pattern, one or more impacts by a projectile may be needed to reveal the entire hidden image 18. In the left side view of FIG. 5B the liquid crystal display device 10C is shown in its initial state where one cannot see the hidden image 18 (i.e., the imprinting structure 70 cannot be seen). Impact of a projectile outside of the pattern, design or image (e.g., heart shape) of the imprinting structure 70 (e.g., in the rigid areas that do not allow or that limit deformation of the back substrate) will not reveal the pattern, design or image of the imprinting structure 70 (heart shape). Impact of a projectile on a portion of the front surface 44 of the liquid crystal display device overlying and overlapping the pattern, design or image of the imprinting structure 70, causes the (heart shaped) pattern, design or image of the imprinting structure 70 to be imprinted onto the liquid crystal layer, revealing the pattern, design or image of the imprinting structure (in this case the heart shape) by corresponding regions of the liquid crystal layer having contrasting textures. In this example, the region inside the heart shape changes to a brighter planar or gray scale texture. Using projectiles to mark the liquid crystal display device provides the entertainment of using multiple impacts to reveal the hidden pattern, design or image of the liquid crystal display device 10C or, for example, in the case of a larger projectile relative to the imprinting structure, can involve accurate placement of the projectile. The erase electronics can be used to apply the voltage waveform that changes the texture of the cholesteric liquid crystal material to the initial texture thereby erasing at least a portion of the image comprised of the impact marks on the display as well as initializing the liquid crystal display device for making the next image. The liquid crystal display device can be flexed to erase at least a portion of the image as well as initializing the liquid crystal display device for making the next image.

The imprinting can also occur on the liquid crystal display device 10C by using the imprinting instrument 38 rather than or in addition to the impact of projectiles 37 (FIG. 5B), the corresponding image 18 including the imprinted image. The imprinting instrument 38 can comprise any object that is able to form an image 18 (displayed in the front view of the liquid crystal display device 10C as shown in FIG. 5B) by applying pressure on the flexible front substrate and imprinting the pattern, design or image of the imprinting structure 70 on the liquid crystal layer. For example, the imprinting instrument 38 can be a stylus that is pointed or blunt, a finger, polymer, foam, a brush, a roller, a cloth, a liquid jet, a compressed volume of liquid, or an air jet. Depending on the size of the tip of the imprinting instrument 38 and the size of the mark, one or more areas of applied pressure by the imprinting instrument (e.g., rubbings) may be needed to reveal the entire hidden image. Areas of applied pressure outside of the pattern, design or image of the imprinting structure 70 (e.g., heart shape) (e.g., in the rigid areas that do not allow or that limit deformation of the flexible back substrate) will not substantially change a texture of the cholesteric liquid crystal material and will not reveal the pattern, design or image of the imprinting structure 70 (e.g., heart shape). Areas where the pressure is applied on a portion of the flexible front substrate overlying and overlapping the pattern, design or image of the imprinting structure 70, causes the (e.g., heart shaped) pattern, design or image of the imprinting structure 70 to be imprinted onto the liquid crystal layer, revealing the pattern, design or image 18 of the imprinting structure 70 (in this case the heart shape) by corresponding regions of the liquid crystal layer having contrasting textures. Applying the pressure with the imprinting instrument 38 provides an entertaining effect of revealing the hidden pattern, design or image of the liquid crystal display device.

Another application is using the display 66 over existing back structures as the replaceable material layer 68. For example, the display 66 can be placed over a gravestone including chiseled lettering (replaceable material layer 68) and a rubbing can be made to capture the chiseled lettering by imprinting the chiseled lettering on the liquid crystal layer. The pressure is applied using the imprinting instrument 38 such as a brush on the flexible front substrate. This imprints the chiseled text, dates or images from the gravestone on the liquid crystal layer. For example, if a dark initial state is used for the cholesteric liquid crystal material and the applied pressure of a rubbing on the flexible front substrate overlies some areas where the stone was chiseled away (relief) below the display 66, portions of the liquid crystal layer overlying the hard surface surroundings 72 around the imprinting structure 70 will remain dark but portions of the liquid crystal layer overlying the regions 74 where the stone was chiseled away (the relief), along with portions of the flexible back substrate, will deform and the cholesteric liquid crystal material will change to the bright texture, imprinting the material from the gravestone on the display 66. Information can be transferred in other ways such as applying a roller or rubbing a cloth on the display 66 instead of a brush. Information including text or images can be imprinted on the display from any back structures, natural or man made.

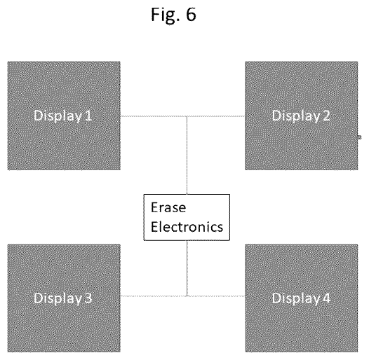

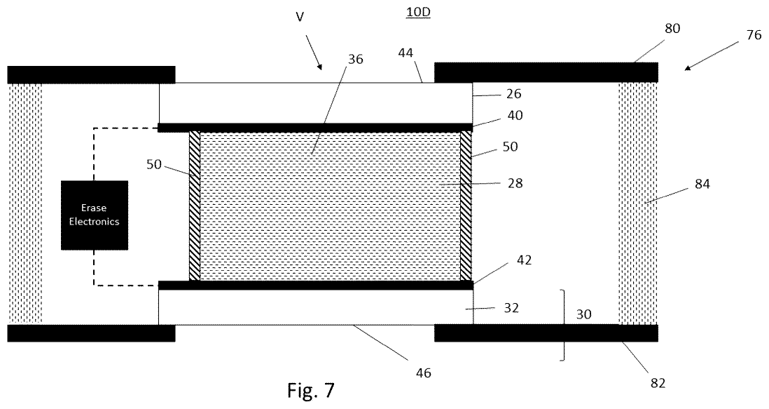

FIG. 6 shows that multiple liquid crystal display devices (e.g., Displays 1-4) that are all electrically connected to erase electronics in common to all of the liquid crystal display devices (e.g., single erase electronics), can be erased by the erase electronics either separately/independently or in any combination. For example, the erase electronics includes a microprocessor and at least one switch or actuator. The erase electronics for multiple displays in this disclosure can be achieved by modifying U.S. Pat. No. 11,609,470 referred to as Sectional Erase, which is incorporated by reference herein. For example, the erase electronics can erase Display 1 only, simultaneously erase Displays 1 and 3 only, or simultaneously erase all of Displays 1-4. The selection of which Displays to erase can be changed by the erase electronics. Each of the Displays 1-4 can take on the design of any of the liquid crystal display devices described in this disclosure in any combination. For example, Display 1 could utilize the design of the liquid crystal display device of FIG. 3 with the elastic material layer 34; Display 2 could utilize the design of the liquid crystal display device of FIG. 4 with elastic material layer 56; Display 3 could utilize the design of the liquid crystal display device of FIG. 5A, 5B in which an imprinting structure 70 forming an image is imprinted on the liquid crystal layer and Display 4 could utilize the design of the liquid crystal display device of FIG. 7 (drum shaped casing). A user could wear each of the Displays 1-4 on different parts of their body and the projectiles, writing instrument or imprinting instrument, and combinations thereof, could be used to apply the pressure on the flexible front substrate to form images on the different displays. Any of the embodiments of liquid crystal display devices of this disclosure can be attached to the human body or worn on the human body using any known means, for example, straps, adhesive, Velcro, sewing, attaching to clothing that is worn by a person. For example, the user could wear a coat or a vest containing pockets that could capture the liquid crystal display devices and hold them in place on the garment (e.g., on at least one of an arm, shoulder, leg, chest or back).

FIG. 2 of the U.S. Pat. No. 11,609,470 patent illustrates an example of a liquid crystal display device comprising four regions A, B, C, D of a liquid crystal layer (which is modified herein to be four regions A, B, C, D of four separate Displays 1-4, respectively). Each Display can be remote from the others, not touching other Displays and not formed integrally together as one display. The Displays 1-4 are each independently erased by sectional switches 11A, 11B, 11C and 11D, respectively. Writing is erased in the Display corresponding to its sectional switch (e.g., the sectional switch closest to it). In one example, multiple Displays are erased by any one of the sectional switches 11A, 11B, 11C or 11D, which are multifunctional. In another example, multiple Displays are erased at once by optional switch 12 in the illustration. Any one or more of switches 11A, 11B, 11C or 11D and 12 can have multiple functions (i.e., to be multifunctional)- to erase one Display or multiple Displays.

Each switch is activated at an activation area. Sectional switches 11A, 11B, 11C, 11D are associated with activation areas 11A′, 11B′, 11C′, 11D′, respectively (FIG. 2 of the U.S. Pat. No. 11,609,470 patent). An example of one activation area is a push button. An example of another activation area is a surface with indicia on it indicating where to place a magnet in proximity to a magnetically activated switch disposed next to the Display. Any number of Displays are possible for erase with the common erase electronics, with four Displays corresponding to regions A, B, C, D of the liquid crystal layer being understood from FIG. 2 of the U.S. Pat. No. 11,609,470 patent (but the regions being spacially separated and not part of the same display). Other types of switches such as a capacitive activated touch switch might also be employed.

As illustrated in the exploded view of FIG. 3A of the U.S. Pat. No. 11,609,470 patent, the conductive sections 5A, 5B, 5C, and 5D each representing a conductive section of a Display 1-4 herein, are connected to common erase electronics 9 by electrical conductors 7A, 7B, 7C, 7D, respectively. One skilled in the art would appreciate that each of the Displays 1-4 would also have an opposite electrically conductive layer, the liquid crystal layer being disposed therebetween.

When a sectional switch 11A, 11B, 11C or 11D is activated, an image on the front view of each Display 1-4 corresponding to regions A, B, C, and D, respectively, is erased. Activating a sectional switch 11A, 11B, 11C or 11D causes the erase electronics 9 to apply an erase voltage waveform to the electrical conductors 7A, 7B, 7C, 7D leading to the conductive sections 5A, 5B, 5C, 5D, of the Displays 1-4, respectively, which erases an image on the corresponding Displays 1-4. For example, activating sectional switch 11A independently erases region A of Display 1; activating sectional switch 11C independently erases region C of Display 3, etc.

Sectional switches 11A, 11B, 11C, and 11D can also be multifunctional, wherein one Display and a combination of Displays are erased. This can be achieved, for example, as selected by a number of times the button is pressed when the erase electronics is programmed to do so. At least one erase voltage waveform can be applied to different conductive sections of each of different Displays based on a number of times or durations by which the mechanical press switch is activated. At least one erase voltage waveform can be applied to different conductive sections based on a number of times or durations by which a magnetically activated switch is activated. An optional activating switch 12 could be employed that erases all Displays 1-4 at the same time as in Example 1 of the U.S. Pat. No. 11,609,470 patent. If switch 12 is multifunctional it could be made to erase Displays 1-4 independently as well as combinations of Displays (any combination of Displays 1-4).

One product design may include a multifunctional actuator (or more than one) that applies the erase voltage waveform to one Display and independently applies the erase voltage waveform to at least two Displays. More specifically, a device may include only one multifunctional actuator that applies the erase voltage waveform to each of the conductive sections of the Displays independently or in combination. Another product design may include at least one monofunctional actuator, each of which applies the erase voltage waveform to only one conductive section, and a multifunctional actuator that applies the erase voltage waveform to one conductive section and independently applies the erase voltage waveform to at least two conductive sections. Other variations in switch function, operation and design that would be apparent to one of ordinary skill in the art are within the spirit and scope of this disclosure. Moreover, throughout this disclosure it will be apparent that covered within the spirit and scope of this disclosure are actuators, which may or may not considered to be switches, that can be activated to result in sectional erase, multiple erase and/or the multifunctional erase. The words switch and actuator are used in this disclosure but should not be interpreted to unduly limit the scope of this disclosure, a switch being considered as one type of actuator. Wherever a switch is discussed in this disclosure it should be appreciated that other actuators could be used. Whenever one actuator is indicated in the disclosure, multiple such actuators may be used.

While the above example illustrates controlling the erasing of four Displays 1-4 with the common erase electronics it is to be understood that any number of Displays can be erased with the common erase electronics with each Display being erased independently of the others. In particular, the common erase electronics can independently and in any combination, erase two Displays, three Displays, four Displays, five Displays, six Displays, seven Displays, eight Displays, nine Displays or ten or more Displays. Each Display could also include at least one, two or more subregions of cholesteric liquid crystal material (e.g., without spacing between them in the plane of the subregions). Multiple Displays can be erased by one or more of: at least one monofunctional actuator, at least one multifunctional actuator, and/or by an optional full erase actuator that erases the entire viewing region, and combinations thereof. Other known actuators may also be used along with the actuators described above.

In one example, FIGS. 4, 5A and 5B of the U.S. Pat. No. 11,609,470 patent show electronic schematic diagrams of erase electronics 9 that can be used to apply an erase voltage waveform for four Displays 1-4 occupying four regions A, B, C, and D, respectively. Terminals 7A′, 7B′, 7C′, 7D′ and 8′ of FIG. 4 of the U.S. Pat. No. 11,609,470 patent are connected to electrical conductors 7A, 7B, 7C, 7D, and 8 of FIG. 3 of the U.S. Pat. No. 11,609,470 patent, respectively. High-side drivers 250 are provided to connect terminals 7A′, 7B′, 7C′, 7D′, and 8′ to voltage supply 240 as is known in the art (see for example U.S. Pat. No. 10,558,065). Low-side drivers 260 are provided to connect the terminals 7A′, 7B′, 7C′, 7D′, and 8′ to ground. Current limiting resistors 230 (optional) are included. Control signals 270 through 284 are output from microprocessor 290 and are sequenced to enable/disable the drivers to produce the required drive waveforms to terminals 7A′, 7B′, 7C′, 7D′ and 8′. Implementations of voltage supply 240 and control logic for sequencing control signals 270 to 284 are well-known in the art. Power is supplied by power source 63. The microcontroller 290 additionally controls the step-up converter 265 to generate a suitable level of voltage supply 240. If the voltage at voltage supply 240 is less than the voltage level required, then the microcontroller 290 provides a PWM signal to step-up converter input 276 until the voltage at voltage supply 240 is greater than or equal to the voltage level required.

FIG. 5B of the U.S. Pat. No. 11,609,470 patent illustrates circuitry for sectional switches 11A, 11B, 11C, 11D, and switch 12 in the example of four Displays. The switches can be mechanical push button activated switches, magnetically activated switches, or any another type of switch such as a capacitive activated touch switch that could also be employed. Magnetically activated switches can be used. FIG. 5A of the U.S. Pat. No. 11,609,470 patent illustrates optional resistors 80 that may be employed which are connected between terminals 7A′, 7B′, 7C′, 7D′ and terminal 8′ as indicated in FIG. 5A. The resistors may be used for multiple purposes. In the case where the slow discharge waveform is implemented, the resistor may be used for discharging the display as known in prior art. In the case where the stylus contains the erase electronics, discussed in the next paragraph, the resistor may be used for automatically detecting the contact of the stylus terminals with terminals on the writing device (U.S. patent application Ser. No. 17/168,507). FIGS. 4, 5A and 5B of the U.S. Pat. No. 11,609,470 patent illustrate switch 12 for applying erase voltage waveforms to all conductive sections 5A, 5B, 5C, and 5D, these being parts of Displays 1-4, respectively, all together with one button. However, the circuitry and or firmware could be arranged or modified so that any combination of Displays could be selected to multiply erase together (one after the next or all at the same time) with a single button press, a sequence of button presses, durations of button presses or other variations.

Another form of erasing the sectioned writing tablet is possible wherein the erase electronics 9 of FIG. 4 of the U.S. Pat. No. 11,609,470 patent are contained within a stylus. With stylus erase, in the example of four Displays, the activation areas, buttons 11A′, 11B′, 11C′, and 11D′ in FIG. 2 of the U.S. Pat. No. 11,609,470 patent, are replaced by terminals, for example, in the housing 13 of each Display (as disclosed in U.S. patent application Ser. No. 17/380,812, which is incorporated by reference). Optional resistors of FIG. 5A are also located within the housing 13. As further disclosed in that patent application, the circuitry could be adjusted to allow the stylus to detect when electrical contact is made with the terminals on housing with terminals on the stylus so that the erase voltage waveform is automatically applied to erase an image.

It is to be understood that methods for erasing one or multiple Displays, or erasing all Displays at once, are possible using one switch 12 or another multifunctional switch shown in the U.S. Pat. No. 11,609,470 patent. Use of the microprocessor to make switches multi-functional offers convenience, flexibility and possibly cost in achieving a wide range of switching possibilities.

One embodiment is fabric on which the liquid crystal display device is attached or to which it is integrally formed. In particular, an aspect is clothing comprised of the fabric. In the liquid crystal display device shown in FIG. 3, for example, without the optional side casing 52 and the optional front bezel 54, the optional back casing 48 can instead be a fabric back layer. Any of the embodiments of the liquid crystal display devices of this disclosure can be similarly modified and placed on clothing (e.g., a textured back layer), the human body or on a moving or stationary target.

Another embodiment of a liquid crystal display device 10D is shown by FIG. 7. It has a casing 76 in a shape of a drum frame. A flexible back substrate 32 is located in back of the liquid crystal layer 28. For example, the flexible back substrate 32 and the back casing 82 form part of the elastic back structure 30. The casing 76 encases a portion of the front surface 44 (a front casing 80 part of the casing 76), a portion of the back surface 46 (the back casing 82 part of the casing 76) and optionally sides of the liquid crystal display device (a side casing 84 part of the casing 76). Like a drum, in this example this display design leaves a central portion of the flexible front substrate 26 uncovered by the front casing 80 and a central portion of the flexible back substrate 32 uncovered by the back casing 82 that are able to locally deform upon application of pressure on the flexible front substrate 26. Application of pressure on the front surface 44 of the liquid crystal display device causes local deformation of the flexible front substrate 26, the liquid crystal layer 28 and the flexible back substrate 32. The flexible back substrate 32 locally deforms in the region of the back surface 46 of the liquid crystal display device that is not supported by the back casing 82. The flexible back substrate 32 locally deforms behind its resting position upon application of pressure. The applied pressure also causes local deformation of the optional front and back electrically conductive layers 40, 42 and the optional light absorbing layer. This local deformation of the multiple layers, including the local deformation of the flexible back substrate 32 that is unsupported by the back casing 82, causes the cholesteric liquid crystal material 36 to change its texture to form an image. The erase electronics can be used to apply the voltage waveform that changes the texture of the cholesteric liquid crystal material 36 to the initial texture thereby erasing at least a portion of the image as well as initializing the liquid crystal display device for making the next image. The liquid crystal display device can be flexed to erase at least a portion of the image as well as initializing the liquid crystal display device for making the next image.

Referring now to more detailed features of the liquid crystal display devices of all embodiments of this disclosure, the flexible front substrate can include at least a portion that is transparent, semitransparent, opaque, or colored. Also, in all embodiments of this disclosure the flexible back substrate, the elastic back substrate, the elastic material layer, and/or the back casing can be transparent, or can be semitransparent, opaque, or colored to serve as a light absorbing background. In all embodiments of the disclosure the flexible front substrate and the flexible back substrate can be formed of any suitable polymer material, for example, polyethylene terephthalate (PET), polycarbonate (PC), polyvinyl chloride (PVC), poly(ethylene-vinyl acetate) (PEVA), or acrylonitrile butadiene styrene (ABS).

The light absorbing layer can be coated or laminated on, or can be a part of, the elastic material layer, the flexible back substrate, the elastic back substrate or the back casing. The light can also be absorbed by a light absorbing layer on the flexible front substrate or in the liquid crystal layer. In all of these cases, the light absorbing layer can be patterned or not. If the flexible back substrate, elastic back substrate, elastic material layer, and/or the back casing are light absorbing then a separate light absorbing layer may be omitted. The light absorbing layer can be omitted from the liquid crystal display device altogether, e.g., the display can be placed on any light absorbing surface, for example, on a wall, a desk or on clothing. Such a display could be completely transparent or include semitransparent components. The light absorbing layer may be flexible when used with a flexible back substrate, with an elastic back substrate or with an elastic material layer. When the light absorbing layer is patterned, it can be rigid or flexible.

The front and the back electrically conductive layers are formed of a suitably electrically conductive material, for example, conductive polymer (CP) or indium tin oxide. In all embodiments of the disclosure, the front and back electrically conductive layers are independently transparent, semitransparent or opaque and are, in particular, transparent. The front and back electrically conductive layers might or might not be the same as each other and they may be unpatterned or patterned. The distance between the front and back electrically conductive layers in the z direction of the liquid crystal display device, which extends perpendicular to the planes of the flexible front substrate and the flexible back substrate, the elastic back substrate or the elastic material layer, is referred to as the cell gap. The planes of the flexible front substrate, the flexible back substrate, the elastic back substrate or the elastic material layer, are referred to as x,y planes. If no electrically conductive layers are present, the distance between: i) the flexible front substrate, and ii) the flexible back substrate, the elastic back substrate or the elastic material layer, which is most proximal to the flexible front substrate, in the z direction of the liquid crystal display device, is referred to as the cell gap. Disposed in the liquid crystal layer within the cell gap are optional spacers having a size that approximates the cell gap (e.g., spherical spacers). The liquid crystal layer can include cholesteric liquid crystal material dispersed in a polymer matrix or no such polymer matrix in which the cholesteric liquid crystal material is dispersed. The cell gap has a size, for example, in a range of about 2 microns to about 10 microns, in particular from about 2 microns to about 4 microns, most specifically about 2 microns in size. In one nonlimiting example, the front electrically conductive layer and the back electrically conductive layer can be adjacent to the liquid crystal layer and more specifically can be formed as two coatings, respectively, one on the inside of the flexible front substrate and one on the inside of the flexible back substrate, respectively. The flexible back substrate and the flexible front substrate, each having the respective electrically conductive layer, are extended to create a bottom ledge and a top ledge. The transparent front and back electrically conductive layers are/may be disposed on the ledges, respectively, for connecting to the erase electronics. The conductor on the bottom and top ledges does not have to be the same as the electrically conductive layers on the rest of the viewing area.

The optional front and back electrically conductive layers can be connected to erase circuitry adapted to apply an appropriate voltage pulse V₂ that refreshes the entire device (i.e., erases the entire viewing surface) to the initial reflective texture or to the initial focal conic texture, creating a new full page upon which to mark again. The erase circuitry can be located in the back casing of the liquid crystal display device or in a capsule of the liquid crystal display device. In a variation, the erase circuitry does not have to be permanently attached to the liquid crystal display device. For example, the erase circuitry could be a separate unit from the liquid crystal display device which it periodically electrically engages when erasing is desired (see U.S. Pat. No. 9,651,813 which is incorporated by reference). The voltage profile needed to drive the cholesteric liquid crystal to the reflective or planar texture, in both cases where the erase circuitry is part of the liquid crystal display device or a separate unit from it, obeys the well-known electro-optical transition mechanisms of cholesteric liquid crystals (U.S. Pat. Nos. 5,437,811 and 5,453,863, which are incorporated herein by reference). A suitable voltage pulse or pulse sequence provided by erase circuitry to drive the cholesteric liquid crystal to the reflective or planar texture is sufficient to erase impact marks and refresh or initialize the liquid crystal display device. As in the embodiments described above, a constant voltage need not be applied to maintain the reflective texture or the transmissive texture.

In an embodiment, the liquid crystal layer is adapted so suitable mechanical flexing of the liquid crystal display device will initialize the cholesteric liquid crystal material to the reflective texture as well as erase a mark, enabling the liquid crystal display device to be reused (Flex to Erase). In this regard, the liquid crystal display device can optionally include the front and back electrically conductive layers on either side of the liquid crystal layer, so that erasing may still occur electronically, as a variation of operation. The operation of flexing provides an alternative way of erasing the liquid crystal display device instead of applying voltage. When flexing the liquid crystal display device to erase it, the optional front and back electrically conductive layers are flexed along with the rest of the liquid crystal display device. When one wants to apply marks on the liquid crystal display device (after flex erasing or not) and to erase this by applying voltage, that is also possible. Different modes of flexing can be applied to the written-on liquid crystal display device to achieve full erasing of the image. Full erase to the reflective texture employs ripples of flexural stress traveling across the flexible liquid crystal display device. In one example embodiment, to enable use of flex to erase, the liquid crystal display device can be removed from an optional back casing, a side casing or a front bezel, which are rigid. See U.S. Patent application publication US 2022/0365385, directed to a display that is Flex Erased illustrating the flex erasing procedure, which is incorporated herein by reference in its entirety. For example, one can flex the liquid crystal display device by holding it with both hands and bending it (bend to erase). In another example, the liquid crystal display device may be flexed by shaking it until erasing is achieved (shake to erase). If the substrates are suitably thin, the liquid crystal display device can be rolled inwards and/or outwards flexing the entire viewing area permitting useful applications such as scrolls that erase the impact marks when rolled in and out (roll to erase). Flexing across the viewing area can also be achieved by peeling the flexible liquid crystal display device from an object that it contacts (peel to erase). There are many other examples of flexing of the substrates that can be used to achieve full erasing such as torsion and twisting, even crumpling.

The multilayer liquid crystal display device may be flexible, for example, when it is designed to be erased by flexing. Of course, this does not prevent the liquid crystal display device from including inflexible elements so long as they do not, for example, prevent erasing by flexing it. In one example, the back substrate could be a thicker element that enables less flexing of the multilayer liquid crystal display device but still enough to enable the flexing to erase it. Sides of the liquid crystal display device can be sealed in ways known to those having ordinary skill in the art including, but not limited to, sealing gaskets and laser singulation. For example, such sealing prevents delamination when the liquid crystal display device is flexed to erase it. In another example, the liquid crystal display device might include an inflexible frame or bezel but still enables flexing that erases it. On the other hand, the liquid crystal display device may be partially inflexible, such as when not being designed to employ flexing to erase it.

The seal 50 can be located, for example, between the flexible front substrate and the flexible back substrate that are coated with the front and back electrically conductive layers. The seal 50 confines the sides of the liquid crystal layer inside the perimeter. The seal 50 can comprise elastomeric material, adhesive material (e.g., cured adhesive) and/or welded material such as disclosed in U.S. Pat. No. 8,958,048, which is incorporated herein by reference in its entirety. A seal 50 that is welded, such as may be implemented by a laser or heat, may be used in some applications; however, a seal 50 of adhesive in particular is used since it not only completely surrounds the liquid crystal in one aspect, but also provides robust flexing of the writing tablet without damage. A seal 50 that is welded may not completely surround the liquid crystal material since welding can easily destroy the ledges of exposed electrically conductive layers. The seal 50 may comprise a weld of the flexible front substrate and the flexible back substrate, a bead of elastomeric material or a bead of adhesive material.

If the seal 50 is comprised of an adhesive material it further allows for confining the liquid crystal at ledges where portions of the front electrically conductive layer and the back electrically conductive layer are disposed on the ledges, respectively. The ledges are used to enable application of voltage waveforms to the front and back electrically conductive layers to erase marks on the liquid crystal layer and to reinitialize the liquid crystal display device for future marking. In the case of a seal that is welded, the seal may not be present on or near the ledges to avoid electrically shorting the two electrically conductive layers together or destroying the electrical connection between the electrically conductive layer and a conductive lead that is on the ledge, by the laser or heat weld. An insulating layer may be added at the location of ledges to prevent shorting or a damaged electrical connection.

The disclosure now presents particular Examples, which should not be used in any way to limit the subject matter as defined in the claims.

### Example 1

The front casing of a Boogie Board® DashBoard® liquid crystal display device was separated from the back casing to reveal clear tape holding down the display to the back casing. This tape was removed to release the display and an elastic material layer was placed between the back casing and the flexible back substrate of the display (gray colored substrate). The elastic material was packing foam such as ULINE® perforated foam roll S-19360P.

After the elastic material layer was placed behind the display, the clear tape was reused to secure the display and the elastic material layer to the back casing. The front casing was reattached to the back casing using longer screws to accommodate the thickness of the elastic material layer.

Using an inkjet printer an image of a target was printed on the front marking surface as a graphics layer using semitransparent blue and opaque black ink, forming the assembled liquid crystal display device (having a design similar to FIG. 1A-F—printed graphics). When a soft fast projectile hit the target on the black region the impact mark was obscured, while in the blue region the impact mark appeared white. The liquid crystal display device was also written on with the flesh of a finger and a blunt instrument having a rounded end. The attached erase electronics were used to erase the images from the liquid crystal display device.

### Example 2

A Boogie Board® Dashboard® liquid crystal display device was disassembled. The front casing was separated from the back casing to reveal clear tape holding down the display to the back casing. This tape was removed to release the display.

A 1 mm thick piece of acrylic sheet the size of the intended viewing area of the display was used to fabricate a grid pattern of 1 cm by 1 cm square holes separated by 3 mm on the entirety of the acrylic sheet. This cutout acrylic sheet was placed between the back casing and the back of the display. Clear tape was reused to secure the display and the patterned acrylic sheet to the back casing. The front casing was reattached to the back casing using the longer screws to accommodate the acrylic sheet thickness. Once assembled, the grid pattern was visible through the semitransparent liquid crystal display device (having a design similar to FIG. 4—template between display and casing). When the liquid crystal display device was struck with a soft fast projectile either a splatter impact mark or a square pattern was created when the cholesteric liquid crystal material reoriented to the planar texture. The liquid crystal display device was reset using the connected erase electronics (i.e., the square grid pattern impact marks and the splatter impact marks were erased). A pointed stylus was also used as an imprinting instrument and scribbles over a region on the flexible front substrate overlying the cutouts of the acrylic sheet imprinted planar texture squares on the liquid crystal layer. The imprinted square shapes were erased using the attached erase electronics.

### Example 3

A commercially available Boogie Board® Black VersaNotes® liquid crystal display device, designed to be written or drawn on using a stylus having a pointed tip or the tip of a fingernail, was placed on a rigid template made of 2 mm acrylic (material 1) with a heart shape cut out in the middle that was filled with ULINE® perforated foam roll S-19360P (material 2) (patterned elastic material layer having regions of materials 1 and 2 having different elasticities). This pattern was not visible through the black (focal conic initial texture) assembled liquid crystal display device (having a design similar to FIGS. 5A and 5B—hidden image) when there was no impact from a projectile. The black light absorbing layer of the display hid the image of the heart shape. When a dart hit the area with heart shaped outline, the pattern was imprinted onto the liquid crystal layer and the liquid crystal display device was marked. Continuous or accurate impact over the heart shaped outline revealed the whole heart shaped pattern. The rest of the region outside the heart shaped pattern was more difficult to mark. A VersaPen® stylus having a pointed tip was used to reset the liquid crystal display device (i.e., the eraser part of the pen was applied to the erase terminals of the erase electronics of the liquid crystal display device to erase the impact marks). To increase the resolution of the hidden image, a PSA back layer can be added between the display and the patterned elastic material layer (rigid template and foam), or the PSA can be applied in the acrylic area only. The rigid template can be replaced with any manner of shapes besides the heart shape and it need not be rigid but can include materials of different elasticity or softness. As imprinting instruments a brush and roller were also used to apply pressure on the flexible front substrate overlying the heart shape cutout and revealed the heart shaped hidden image imprinted on the liquid crystal layer. This hidden image formed by imprinting using the imprinting instrument was also erased by activating the erase electronics.

### Example 4

A Boogie Board® Dashboard® display was disassembled. The front casing was separated from the back casing to reveal clear tape holding down the display to the back casing. This tape was removed to release the display.

A rectangular hole was cut out of the back casing so that the display was unsupported everywhere except for a region about 4 mm wide around the perimeter of the display avoiding the ledge areas. The back side of the display was affixed with double sided tape to the back casing. The front casing was reattached to the back casing using the original screws. Upon assembly, the result was a liquid crystal display device (having a design similar to FIG. 7—drum) that was only supported around the perimeter. When the liquid crystal display device was struck with a soft fast projectile an impact mark was created when the cholesteric liquid crystal material reoriented to the planar texture. The liquid crystal layer and the flexible back substrate, along with the back electrically conductive layer and light absorbing layer on the flexible back substrate, locally deformed in response to the impact of the soft projectile. The flexible back substrate that was unsupported by the frame deformed further back of its resting state in a direction toward the back surface of the display that was the outermost surface of the flexible back substrate. The display was reset (i.e., the impact marks were erased) using the connected erase electronics.

Many modifications and variations will be apparent to those of ordinary skill in the art in light of the foregoing disclosure. Therefore, it is to be understood that, within the scope of the appended claims, the invention can be practiced otherwise than has been specifically shown and described.

What is claimed is:

1. A liquid crystal display device comprising:
a flexible front substrate;
a liquid crystal layer comprising cholesteric liquid crystal material;
i) a flexible back substrate and an elastic material layer; or ii) an elastic back substrate;
wherein said flexible front substrate is located more proximal to a person viewing the liquid crystal display device than is said liquid crystal layer;
wherein i) said flexible back substrate and said elastic material layer; and ii) said elastic back substrate, when present, are located in back of said liquid crystal layer;
wherein pressure applied on said flexible front substrate changes a texture of said cholesteric liquid crystal material which displays an image;
wherein said pressure is from at least one of: a) impact of a projectile, a corresponding said image including an impact mark; b) a writing instrument, a corresponding said image including writing or drawing; and c) an imprinting instrument, a corresponding said image including an imprinted image;
wherein application of an electric field to said liquid crystal layer or flexing of said liquid crystal layer erases at least a portion of said image.

2. The liquid crystal display device of claim 1 wherein at least a portion of said elastic material layer and at least a portion of said elastic back substrate, when present, have a Shore 00 hardness not greater than at least one of the following values: 90, 75, 60, 50, 40, 30, 20, 10.

3. The liquid crystal display device of claim 1 wherein said elastic material layer and said elastic back substrate, when present, comprise at least one of vinyl sheets with Shore A hardness less than 80, bubble wrap, neoprene, synthetic flash spun high-density polyethylene fibers, fleece fabric, carpeting material, elastomer sheets, clothing fabric, canvas, a layer of cotton balls, a sheet of wool, foam and bubble wrap.

4. The liquid crystal display device of claim 1 wherein said elastic material layer and said elastic back substrate, when present, comprise a plurality of first regions comprising a first material and a plurality of second regions comprising a second material, wherein said first material has different elasticity than said second material.

5. The liquid crystal display device of claim 1 wherein said elastic material layer and said elastic back substrate, when present, comprise a plurality of first regions comprising a first material and a plurality of second regions comprising a second material, wherein said first material has: i) different mechanical properties other than elasticity; or ii) different thickness, than said second material.

6. The liquid crystal display device of claim 1 wherein said elastic material layer and said elastic back substrate, when present, comprise a plurality of first regions comprising a first material and a plurality of second regions comprising a second material, wherein said first material has different color or opacity, or other optical properties, than said second material.

7. The liquid crystal display device of claim 1 comprising a back material layer located in back of: i) said flexible back substrate and said elastic material layer; and ii) said elastic back substrate, when present, wherein said back material layer comprises an imprinting structure forming a pattern, design or image that is adapted to be imprinted on said liquid crystal layer as a result of said pressure applied on said flexible front substrate.

8. The liquid crystal display device of claim 7 wherein said back material layer is replaceable.

9. The liquid crystal display device of claim 1 comprising a back material layer located in back of: i) said flexible back substrate and said elastic material layer; and ii) said elastic back substrate, when present, wherein said back material layer comprises a body portion that is rigid or flexible and cutouts in said body portion forming a pattern, design or image that is adapted to be imprinted on said liquid crystal layer as a result of the pressure applied on said flexible front substrate.

10. The liquid crystal display device of claim 7 comprising a light absorbing layer that absorbs light passing through said liquid crystal layer and hides said imprinting structure in an initial state of the liquid crystal display device.

11. The liquid crystal display device of claim 1 comprising at least one graphics layer or patterned layer disposed on or inside the liquid crystal display device that is visible to a person viewing the liquid crystal display device, wherein the at least one said graphics layer or said patterned layer is optionally replaceable from the liquid crystal display device and optionally includes an image that can be erased by wiping.

12. The liquid crystal display device of claim 11 wherein the at least one said graphics layer or patterned layer gives the liquid crystal display device features of a target to which a person can aim the projectile.

13. The liquid crystal display device of claim 1 comprising a front graphics layer near said flexible front substrate, wherein said front graphics layer includes an opaque portion and a transparent portion or a semitransparent portion, wherein said opaque portion masks said liquid crystal layer underlying said opaque portion and wherein marks are formed in said liquid crystal layer underlying said transparent portion or said semitransparent portion by the applied pressure and are visible on the liquid crystal display device.

14. The liquid crystal display device of claim 1 comprising a front graphics layer near said flexible front substrate, wherein said front graphics layer includes a body portion comprising a flexible or rigid material and cutouts formed in said body portion, wherein said cutouts contain air, fluid or a soft material, and said body portion prevents marking of said liquid crystal layer underlying said body portion.

15. The liquid crystal display device of claim 1 comprising said projectile as a toy which is a ball, a dart, a bullet or an arrow comprising at least one of soft polymer, foam, a liquid and a gel, or is a liquid jet, a compressed volume of liquid, or an air jet.

16. The liquid crystal display device of claim 1 wherein said image includes a mark inside of which said cholesteric liquid crystal material has a first texture that is one of a planar texture, a gray scale texture or a focal conic texture and outside said mark said cholesteric liquid crystal material has a different second texture that is one of the planar texture, the gray scale texture or the focal conic texture.

17. The liquid crystal display device of claim 1 wherein said impact mark is in the form of a splatter.

18. The liquid crystal display device of claim 1 wherein said writing instrument includes flesh of a finger, a blunt instrument other than said flesh of a finger, a foot, a soft polymer, foam, a liquid jet, a compressed volume of liquid, an air jet or a pointed stylus.

19. The liquid crystal display device of claim 1 wherein said imprinting instrument includes a stylus that is pointed or blunt, a finger, polymer, foam, a roller, a cloth, a liquid jet, a compressed volume of liquid, or an air jet.

20. The liquid crystal display device of claim 1 comprising a back casing in back of said elastic material layer and said elastic back substrate, when present, that is rigid or flexible, further comprising an optional side casing and an optional front bezel pressing against a perimeter of said flexible front substrate.

21. The liquid crystal display device of claim 1 comprising electrically conductive layers between which said liquid crystal layer is disposed, and erase electronics adapted to apply a voltage waveform to said electrically conductive layers that applies the electric field to said liquid crystal layer to erase at least a portion of said image and initialize said liquid crystal display device for making a new said image.

22. Multiple of the liquid crystal display devices of claim 21 which are all electrically connected to common said erase electronics that applies the electric field so as to carry out erasing of at least a portion of said image of the liquid crystal display devices independently or in combination.

23. The multiple liquid crystal display devices of claim 22 wherein said common erase electronics includes at least one actuator that independently applies an erase voltage waveform to said electrically conductive layers of each of at least two of the liquid crystal display devices.

24. The multiple liquid crystal display devices of claim 22 wherein said common erase electronics includes at least one actuator that independently applies an erase voltage waveform to said electrically conductive layers of each of the liquid crystal display devices, and that applies erase voltage waveforms to said electrically conductive layers of at least two of the liquid crystal display devices in combination.

25. Fabric on which the liquid crystal display device of claim 1 is attached or to which the liquid crystal display device is integrally formed.

26. The liquid crystal display device of claim 1 wherein said flexible front substrate is transparent, semi-transparent, opaque or colored.

27. A liquid crystal display device comprising:
a flexible front substrate;
a liquid crystal layer comprising cholesteric liquid crystal material;
elastic back structure that makes the liquid crystal display device elastic;
wherein said flexible front substrate is located more proximal to a person viewing the liquid crystal display device than is said liquid crystal layer;
wherein at least a part of said elastic back structure is located in back of said liquid crystal layer;
wherein pressure applied on said flexible front substrate changes a texture of said cholesteric liquid crystal material which displays an image;
wherein application of an electric field to said liquid crystal layer or flexing of said liquid crystal layer erases at least a portion of said image.

28. The liquid crystal display device of claim 27 wherein said elastic back structure comprises a flexible back substrate and an elastic material layer located in back of said flexible back substrate, which are located in back of said liquid crystal layer.

29. The liquid crystal display device of claim 28 wherein said elastic material layer comprises a plurality of first regions comprising a first material and a plurality of second regions comprising a second material, wherein said first material has different elasticity than said second material.

30. The liquid crystal display device of claim 27 wherein said elastic back structure comprises an elastic back substrate that is located in back of said liquid crystal layer.

31. The liquid crystal display device of claim 30 wherein said elastic back substrate comprises a plurality of first regions comprising a first material and a plurality of second regions comprising a second material, wherein said first material has different elasticity than said second material.

32. The liquid crystal display device of claim 27 wherein said elastic back structure comprises a flexible back substrate and a back material layer located behind said flexible back substrate, which are located in back of said liquid crystal layer, said back material layer comprising an imprinting structure forming a pattern, design or image that is adapted to be imprinted on said liquid crystal layer as a result of said pressure applied on said flexible front substrate.

33. The liquid crystal display device of claim 32 wherein said back material layer is replaceable.

34. The liquid crystal display device of claim 32 comprising a light absorbing layer that absorbs light passing through said liquid crystal layer and hides said imprinting structure in an initial state of the liquid crystal display device.

35. The liquid crystal display device of claim 27 wherein said elastic back structure comprises a flexible back substrate in back of said liquid crystal layer and a casing that is rigid or flexible having a shape of a drum frame that encases portions of a front, a back and sides of the liquid crystal display device.

36. The liquid crystal display device of claim 27 comprising a front graphics layer near said flexible front substrate, wherein said front graphics layer includes an opaque portion and a transparent portion or a semitransparent portion, wherein said opaque portion masks said liquid crystal layer underlying said opaque portion and wherein marks are formed in said liquid crystal layer underlying said transparent portion or said semitransparent portion by the applied pressure and are visible on the liquid crystal display device.

37. The liquid crystal display device of claim 27 comprising a front graphics layer near said flexible front substrate, wherein said front graphics layer includes a body portion comprising a flexible or rigid material and cutouts formed in said body portion, wherein said cutouts contain air, fluid or a soft material, and said body portion prevents marking of said liquid crystal layer underlying said body portion.

38. The liquid crystal display device of claim 27 wherein said elastic back structure is constructed and arranged to enable a projectile, flesh of a finger, or a blunt instrument other than the flesh of a finger, which applies the pressure on said flexible front substrate, to form said image.

39. The liquid crystal display device of claim 27 wherein at least a portion of said elastic back structure has a Shore 00 hardness not greater than at least one of the following values: 75, 60, 50, 40, 30, 20, 10.

40. The liquid crystal display device of claim 27 wherein said elastic back structure comprises at least one of vinyl sheets with Shore A hardness less than 80, bubble wrap, neoprene, synthetic flash spun high-density polyethylene fibers, fleece fabric, carpeting material, elastomer sheets, clothing fabric, canvas, a layer of cotton balls, a sheet of wool, foam and bubble wrap.
